(19) United States
(12) Patent Application Publication
(10) Pub. No.: US 2005/0128948 A1
(43) Pub. Date: Jun. 16, 2005

(54) Locally stored portion of a calendar structure indicating when interfaces will become available to transmit packets

(76) Inventors: Chen-Chi Kuo, Pleasanton, CA (US); Sridhar Lakshmanamurthy, Sunnyvale, CA (US)

Correspondence Address: BUCKLEY, MASCHOFF, TALWALKAR LLC, 5 ELM STREET, NEW CANAAN, CT, 06840, US

(21) Appl. No.: 10/733,127

(22) Filed: Dec. 11, 2003

(51) Int. Cl. H04L 12/56

(52) U.S. Cl. 370/235; 370/395.4

(57) ABSTRACT

According to some embodiments, a portion of a calendar structure that indicates when interfaces will become available to transmit packets is locally stored at a processing element.

### BACKGROUND

A network device may facilitate an exchange of information packets via a number of different interfaces. For example, a network processor may receive packets and arrange for each packet to be transmitted to another device (e.g., a “downstream” device) through an appropriate outgoing interface.

In some cases, the rate at which packets should be transmitted through a particular interface may be limited. For example, a downstream device might only be able to receive packets at a limited rate. If packets are transmitted to that device at a faster rate, information could be lost. To reduce the likelihood of such a result, a network device may schedule packets to be transmitted through outgoing interfaces at appropriate rates. Moreover, it may be helpful to avoid unnecessary delays when processing and/or scheduling the packets—especially when a network device is associated with a relatively high speed network.

### BRIEF DESCRIPTION OF THE DRAWINGS

FIG. 1 is a block diagram of network device.

FIG. 2 is a block diagram of a processing element.

FIG. 3 is a block diagram of an apparatus.

FIG. 4 is a block diagram of an apparatus according to some embodiments.

FIG. 5 is a flow chart of a method according to some embodiments.

FIG. 6 is an example of an apparatus according to some embodiments.

FIG. 7 is a flow chart of a transmission block method according to some embodiments.

FIG. 8 is a flow chart of a timer block method according to some embodiments.

FIG. 9 is an example of a system including a network processor according to some embodiments.

### DETAILED DESCRIPTION

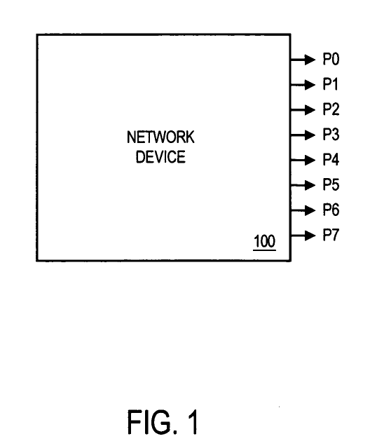

A network device may facilitate an exchange of information packets via a number of different interfaces. For example, FIG. 1 is a block diagram of network device 100 that may receive packets and arrange for each packet to be transmitted to another device (e.g., a “downstream” device) through an appropriate interface. In particular, the network device 100 illustrated in FIG. 1 transmit a packet through one of eight ports (P0 through P7). Note that a network device could include a different number of interfaces.

As used herein, the phrase “network device” may refer to, for example, an apparatus that facilitates an exchange of information via a network, such as a Local Area Network (LAN), or a Wide Area Network (WAN). Moreover, a network device might facilitate an exchange of information packets in accordance with the Fast Ethernet LAN transmission standard 802.3-2002® published by the Institute of Electrical and Electronics Engineers (IEEE). Similarly, a network device may process and/or exchange Asynchronous Transfer Mode (ATM) information in accordance with ATM Forum Technical Committee document number AF-TM-0121.000 entitled “Traffic Management Specification Version 4.1” (March 1999). A network device may be associated with, for example, a network processor, a switch, a router (e.g., an edge router), a layer 3 forwarder, and/or protocol conversion. Examples of network devices include those in the INTEL® IXP 2800 family of network processors.

In some cases, the rate at which packets should be transmitted through a particular interface may be limited. For example, a downstream device might only be able to receive packets at a limited rate. As a result, the network device 100 may schedule packets to be delivered through outgoing interfaces at appropriate rates (e.g., “shaping the traffic” through the interfaces).

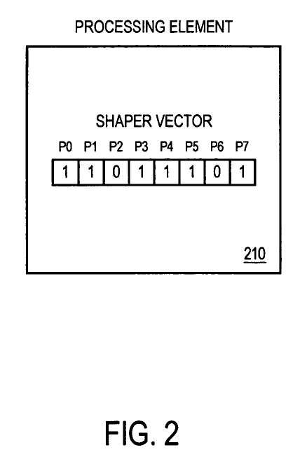

FIG. 2 is a block diagram of a processing element 210 that may be used, for example, by the network device 100 of FIG. 1 to schedule packets through a number of different interfaces. The processing element 210 stores a “shaper vector” (e.g., in local memory or registers) that has a series of bits indicating which interfaces are currently available to transmit packets. As illustrated in FIG. 2, the shaper vector may have eight bits associated with interfaces P0 through P7. In this example, a “1” indicates that an interface is available to transmit packets and a “0” indicates that an interface is not available to transmit packets. Thus, P0 through P7 might be initialized to “1” indicating that all interfaces are originally available to transmit packets.

The shaper vector may be used by the processing element 210 to select an interface through which a packet will be transmitted. For example, if the processing element 210 of FIG. 2 had a packet that needed to be transmitted, it might select P0, P1, P3, P4, P5, or P7 (because those interfaces are currently available) but not P2 or P6 (because those interfaces are not currently available). If the processing element 210 selects P4, it might arrange for the corresponding bit in the shaper vector to be set to “0” (because that interface will not be available to transmit a subsequent packet for a period of time).

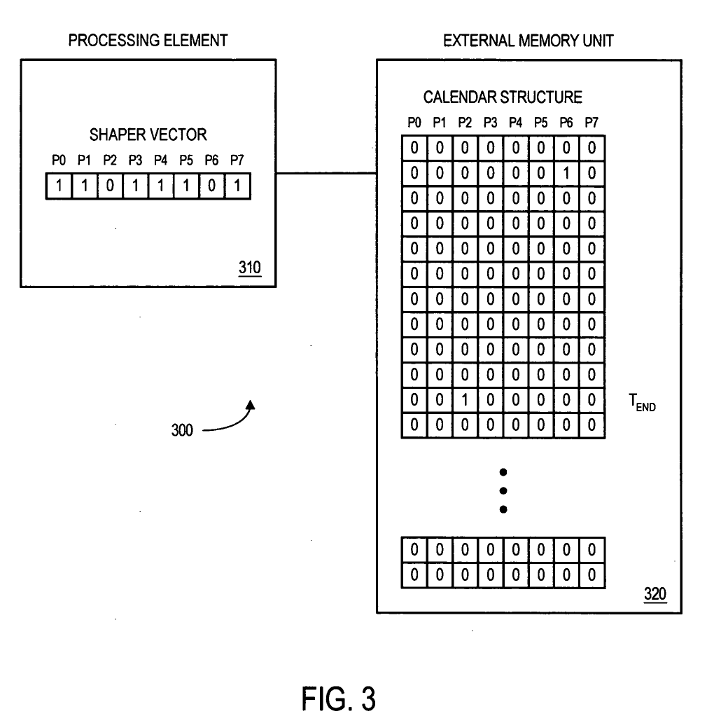

After a packet has been transmitted through an interface, the associated bit the shaper vector may be re-set to “1” (because that interface is again available to transmit a subsequent packet). FIG. 3 is a block diagram of an apparatus 300 including a processing element 310 storing a shaper vector similar to the one described with respect to FIG. 2 (e.g., in memory local to the processing element 310). The apparatus 300 also includes an external memory unit 320 (e.g., external to the processing element 310).

The external memory unit 320 stores a “calendar structure” associated with the interfaces P0 through P7. The calendar structure has a series of rows or “entries” associated with time periods, each entry indicating which interfaces will become available to transmit packets during the associated time period (a “1” indicating that the associated interface will become available and a “0” indicating there is no change in the interface's availability). For example, when P2 was selected to transmit a packet (and bit P2 in the shaper vector was set to “0” indicating that P2 was not available to transmit other packets), a time T_{END} reflecting when the transmission of that packet through P2 would be completed was determined (e.g., based on the size of the packet and/or a data rate associated with P2). Moreover, the appropriate entry in the calendar structure was updated such that bit P2 in the T_{END} entry was set to “1” (indicating that P2 will again be available to transmit packets at that time).

For example, each entry in the calendar structure might represent a one millisecond (msec) time period. In this case, the calendar structure illustrated in FIG. 3 indicates that no interfaces will become available to transmit packet during the current one msec time period (because bits P0 through P7 are all “0” in the first entry). That is, interfaces that are currently available will remain available and interfaces that are not currently available will remain not available.

The calendar structure also indicates that P6 will become available during the next one msec time period (because bit P6 in the second entry is “1,” meaning that the transmission of a packet through P6 will then be completed). At that time, bit P6 in the shaper vector stored at the processing element 310 may be re-set to “1” (so that P6 can be selected to transmit a subsequent packet). In this way, the apparatus 300 may schedule packets to shape traffic flow through a number of different interfaces.

Note that an exchange of information between the processing element 310 and the external memory unit 320 may be relatively slow. As a result, the performance of the apparatus 300 may be reduced. Moreover, only a limited amount of local memory might be available at the processing element 310, and the size of the calendar structure may need to be relatively large (e.g., because the apparatus 300 might need to schedule an interface to transmit a packet for a relatively long period of time when the packet is large and/or the data rate of the interface is slow). Therefore, it might not be practical to improve performance by storing to the entire calendar structure at the processing element 310.

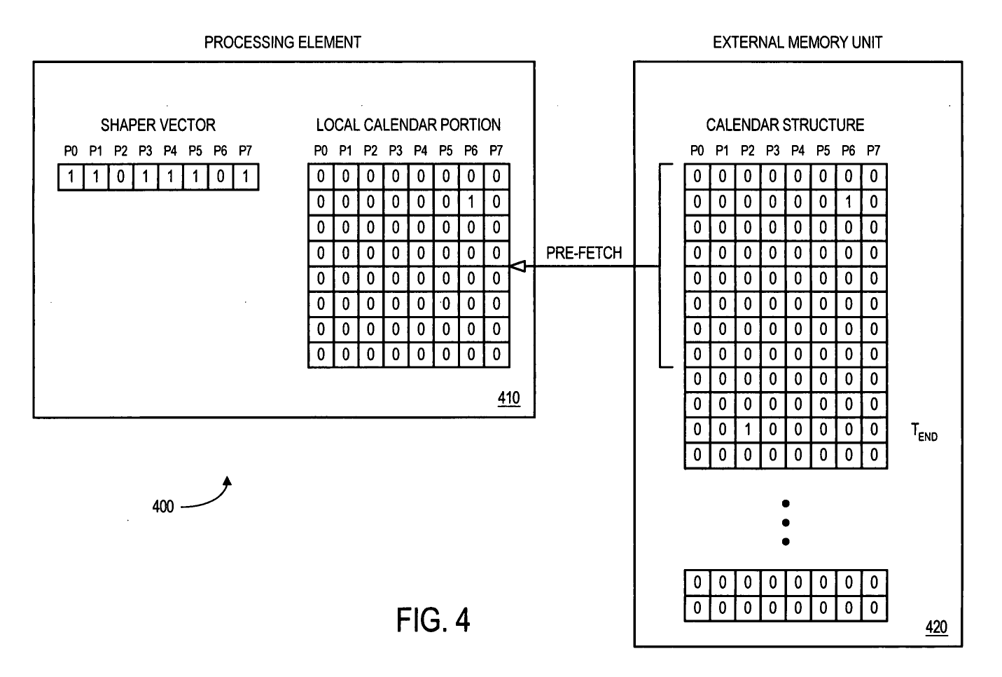

FIG. 4 is a block diagram of an apparatus 400 according to some embodiments. The apparatus 400 includes a processing element 410 that locally stores a shaper vector for interfaces P0 through P7. The apparatus 400 also includes an external memory unit 420 that stores a calendar structure associated with those interfaces. As before, the calendar structure has a series of entries associated with time periods, each entry indicating which interfaces will become available to transmit packets during the associated time period.

According to this embodiment, the processing element 410 also stores a local calendar portion. For example, eight entries from the calendar structure stored in the external memory unit 420 might be retrieved (“pre-fetched”) and stored at the processing element before they are needed. The processing element 410 may then use the local calendar portion to update the shaper vector without experiencing the delays that would otherwise be associated with accessing information from the external memory unit 420. In addition, as the local portion expires, the next subset of entries can be pre-fetched from the external memory unit 420. In this way, the performance of the apparatus 400 may be improved.

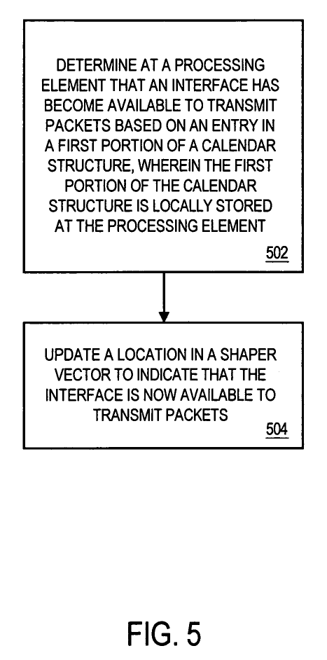

FIG. 5 is a flow chart of a method according to some embodiments. The method may be performed, for example, by the apparatus 400 described with respect to FIG. 4. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine result in performance according to any of the embodiments described herein.

At 502, it is determined at a processing element that an interface has become available to transmit packets based on an entry in a first portion of a calendar structure. Moreover, the first portion of the calendar structure is locally stored at the processing element and a second portion of the calendar structure is stored in memory external to the processing element.

At 504, a location in a shaper vector is updated to indicate that the interface is now available to transmit packets, the shaper vector including locations associated with a plurality of interfaces. For example, a bit in the shaper vector might be re-set to “1” indicating that the associated interface is again available to transmit packets.

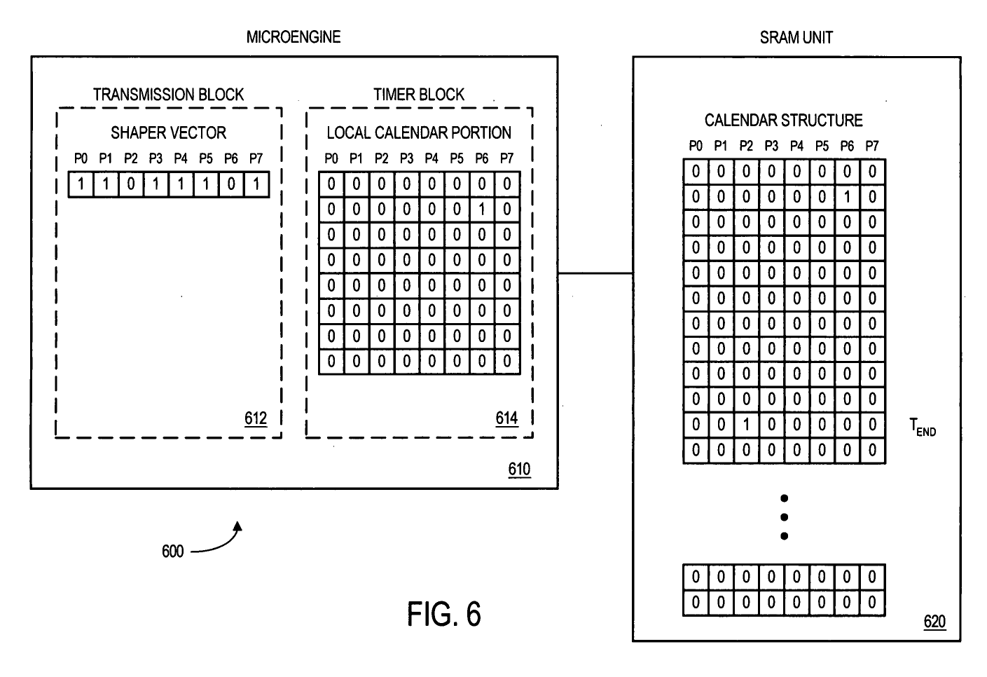

FIG. 6 is an example of an apparatus 600 according to some embodiments. The apparatus includes a microengine 610, such as a multi-threaded Reduced Instruction Set Computer (RISC) device. The microengine 610 includes two functional blocks: a transmission block 612 and a timer block 614. Note that transmission block 612 and the timer block 614 may be associated with different threads executing on the microengine 610. In addition, although a single microengine 610 is illustrated in FIG. 6, the apparatus might include multiple microengines and/or other functional blocks (e.g., an ATM buffer manager block, a queue manager block, and/or a shaper block).

The transmission block 612 updates a shaper vector stored locally at the microengine 610. The shaper vector 612 might be stored, for example, in a General Purpose Register (GPR) or local memory at the microengine 610. The timer block 614 updates a local copy of a calendar portion 614 stored at the microengine 610. The apparatus 600 also includes an Static Random Access Memory (SRAM) unit 620 (external to the microengine 610) that stores the entire calendar structure.

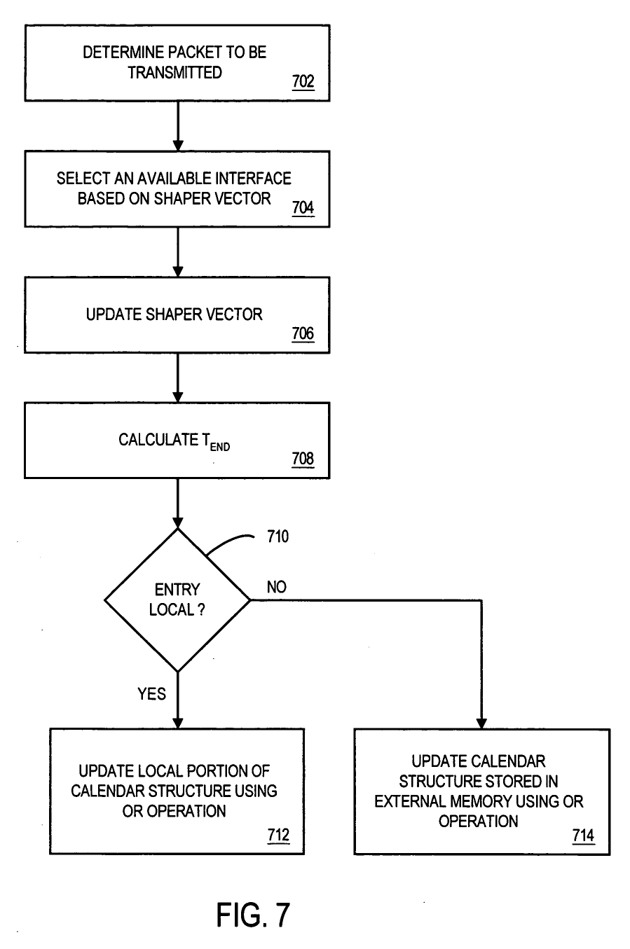

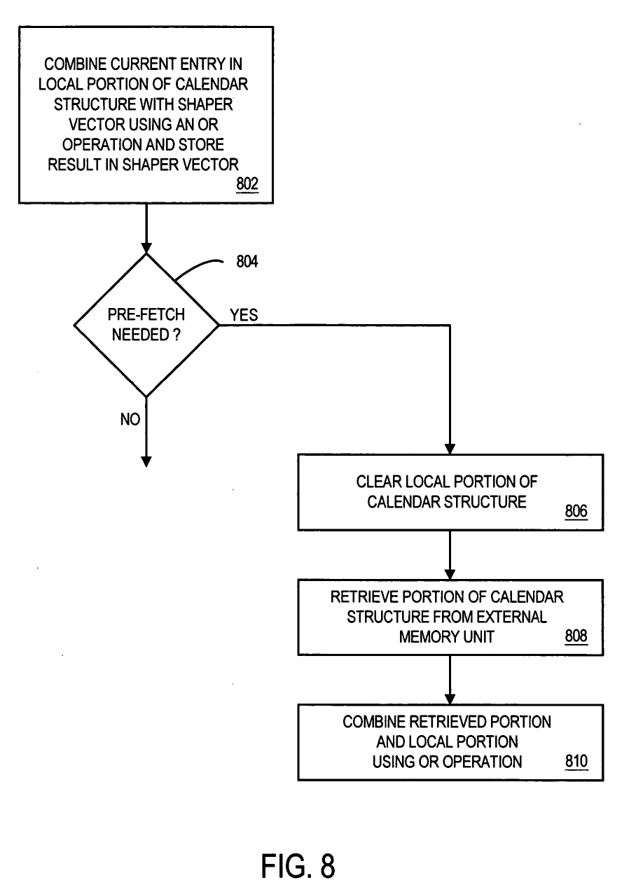

The operation of the apparatus 600 according to some embodiments will now be described with respect to FIGS. 7 and 8. In particular, FIG. 7 is a flow chart of a transmission block 612 method according to some embodiments. At 702, a packet to be transmitted is determined. For example, the transmission block 612 might receive a packet to be transmitted from another microengine or retrieve the packet from a transmission buffer.

At 704, an available interface is selected based on information in a shaper vector. For example, the transmission block 612 might select a port through which the packet will be transmitted by searching for a “1” in the shaper vector. The shaper vector is then updated at 706 (e.g., by setting the appropriate bit to “0” indicating that the selected interface is not available to transmit other packets).

At 708, a time T_{END} when the transmission of the packet through the selected interface will be completed is calculated. For example, the length of the packet might be divided by a transmission rate associated with the selected interface to calculate T_{END}.

The appropriate entry in the calendar structure (associated with time T_{END}) may then be determined and updated to indicate when the selected interface will again become available to transmit packets. Note, however, that the appropriate entry might be stored in the SRAM unit 620 or the local calendar portion at the microengine 610. As a result, it is determined at 710 whether the appropriate entry is stored in the local calendar portion. If so, the transmission block 612 updates the local portion of the calendar structure at 712. For example, the local portion of the calendar structure might be updated if TEND is within the next eight msec. If the appropriate entry is not stored in the local calendar portion, the transmission block 612 updates the calendar structure in the SRAM unit 620 at 714.

FIG. 8 is a flow chart of a timer block 614 method according to some embodiments. Note that when the timer block 614 and the transmission block 612 are associated with different threads executing on the microengine 610, the timer block 614 might “wake” and execute less frequently as compared to the transmission block 612 (e.g., the timer block 614 might execute periodically based on the period of time associated with each entry in the calendar structure).

At 802, the shaper vector is updated based on information in the local portion of the calendar structure. For example, the timer block 614 might combine the shaper vector and the current entry in the local portion of the calendar structure using an OR operation and store the result in the shaper vector. In this case, combining the first entry of the local portion of the calendar structure with the shaper vector illustrated in FIG. 6 would result in the shaper vector remaining unchanged (e.g., because bits P0 through P7 in the first entry are all “0”). Combining the second entry of the local portion of the calendar structure with the shaper vector, however, would transition bit P6 of the shaper vector from “0” to “1” (e.g., because bit P6 in the second entry is “1”). Note that this approach may efficiently handle situations where multiple interfaces become available at substantially the same time (e.g., using a single 8-bit OR operation).

At 804, it is determined if the next portion of the calendar structure stored in the SRAM unit 620 needs to be pre-fetched. For example, the timer block 614 might determine that another subset of calendar entries should be pre-fetched when the entries in the local calendar portion 614 have expired. If no pre-fetch is required, the timer block 614 may be finished until the next entry in the calendar structure is to be evaluated.

If a pre-fetch is required, the timer block 614 may copy information from the SRAM unit 620 into the microengine's local memory. Note, however, that it might take a period of time for the information to be copied. Moreover, the transmission block 612 might select schedule one or more packets during that period of time. As a result, if the transmission block 612 attempts to update the calendar structure in the SRAM unit 620 during that time (e.g., because the appropriate entry is not yet stored at the microengine 610), information could be lost.

To avoid this situation, the local portion of the calendar structure is cleared at 806. For example, the timer block 614 might write a “0” into every bit of every entry of the locally stored calendar structure.

At 808, the timer block 614 retrieves or pre-fetches the next portion of the calendar structure from the SRAM unit 620. During this time, the transmission block 612 will make any updates to the calendar structure by writing to the local portion of the calendar structure (instead of the SRAM unit 620).

At 810, the timer block 614 combines the information from the SRAM unit 620 with the information currently stored in the local portion of the calendar structure using an OR operation, and the result is stored in the local portion of the calendar structure. In this way, any updates to the calendar structure made by the transmission block 612 during the pre-fetch will not be lost.

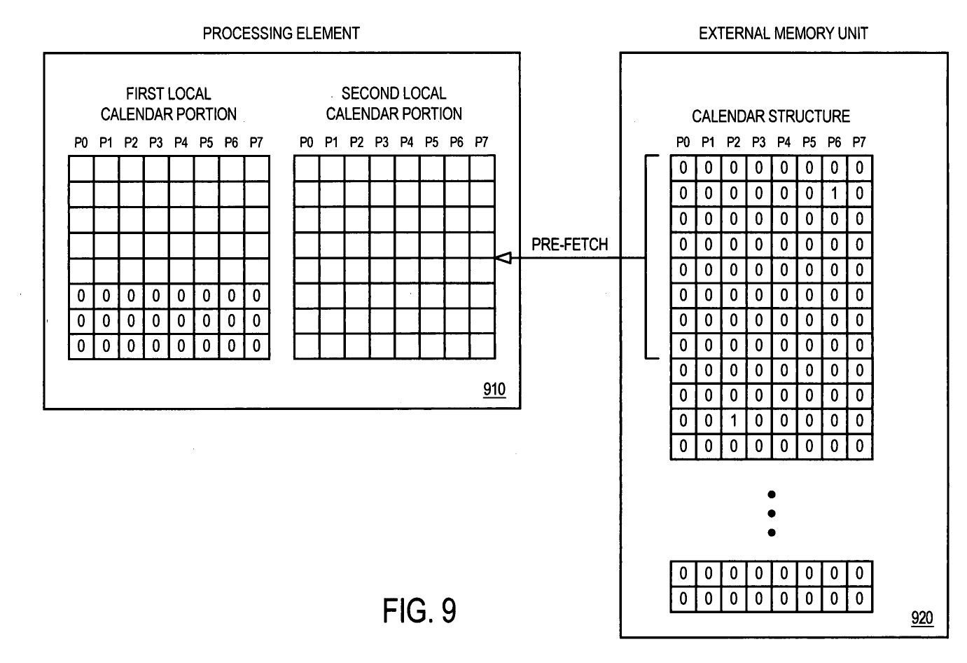

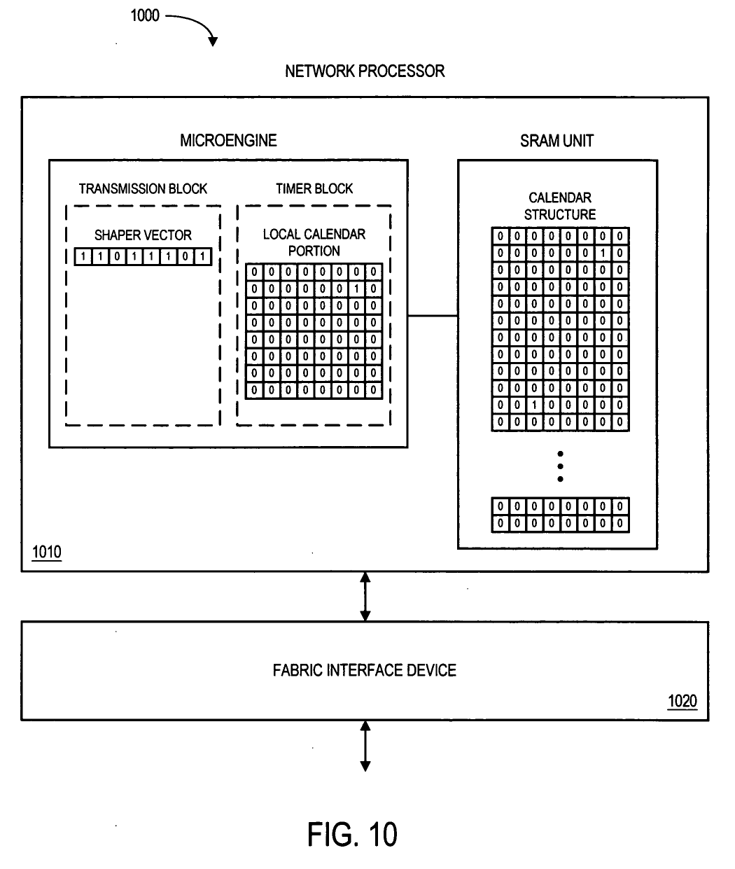

FIG. 9 is an example of a system 900 including a network processor 910 according to some embodiments. The network processor 910 may include a processing element and/or an external memory unit according to any of the embodiments described herein. For example, the network processor 910 might include an SRAM unit to store a calendar structure and microengine that locally stores a portion of the calendar structure. The system 900 may further include a fabric interface device 920, such as a device to exchange ATM information via a network.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although eight entries of the calendar structure have been described as being stored locally at the processing element, fewer or more entries might be stored locally as appropriate. Moreover, although specific functions have been associated with the transmission block and/or the time block, other functional blocks or devices may perform some or all of the functions described herein.

The several embodiments described herein are solely for the purpose of illustration. Persons skilled in the art will recognize from this description other embodiments may be practiced with modifications and alterations limited only by the claims.

1. A method, comprising:
determining at a processing element that an interface has become available to transmit packets based on an entry in a first portion of a calendar structure, wherein the first portion of the calendar structure is locally stored at the processing element and a second portion of the calendar structure is stored in memory external to the processing element; and
updating a location in a shaper vector to indicate that the interface is now available to transmit packets, wherein the shaper vector includes locations associated with a plurality of interfaces.

2. The method of claim 1, wherein the shaper vector has a series of bits indicating which interfaces are currently available to transmit packets, and said updating comprises:
updating the appropriate bit in the shaper vector.

3. The method of claim 2, wherein the calendar structure has a series of entries associated with time periods, each entry having a series of bits indicating which interfaces will become available to transmit packets during the time period associated with the entry.

4. The method of claim 3, wherein said updating comprises:
combining the shaper vector and the appropriate entry in the first portion of the calendar structure using an OR operation and storing the result in the shaper vector.

5. The method of claim 1, further comprising:
pre-fetching a subset of the second portion of the calendar structure from the external memory and locally storing the subset at the processing element as the first portion.

6. The method of claim 5, wherein said pre-fetching comprises:
clearing the first portion of the calendar structure;
retrieving the subset of the second portion from the external memory; and
combining the retrieved information with the first portion using an OR operation and locally storing the result as the first portion of the calendar structure.

7. The method of claim 1, further comprising:
determining a packet to be transmitted via a first interface;
updating a location in the shaper vector to indicate that the first interface is not available;
calculating a time when the first interface will again be available; and
updating an entry in the calendar structure to indicate when the interface will again become available.

8. The method of claim 7, further comprising:
selecting the first interface based on information stored in the shaper vector.

9. The method of claim 7, wherein said calculating comprises dividing the length of the packet by a transmission rate associated with the first interface.

10. The method of claim 7, further comprising:
determining whether the entry in the calendar structure to be updated is stored in the first portion of the calendar structure.

11. The method of claim 7, wherein (i) the determination of the packet to be transmitted, the updating of the shaper vector to indicate that the first interface is not available, and the updating of the calendar structure are performed by a transmission block, and (ii) the determination that an interface has become available to transmit packets based on an entry in a first portion of a calendar structure and the updating of the shaper vector to indicate that the interface is now available are performed by a timer block.

12. An article, comprising:
a storage medium having stored thereon instructions that when executed by a machine result in the following:
determining at a processing element that an interface has become available to transmit packets based on an entry in a first portion of a calendar structure, wherein the first portion of the calendar structure is locally stored at the processing element and a second portion of the calendar structure is stored in memory external to the processing element, and
updating a location in a shaper vector to indicate that the interface is now available to transmit packets, wherein the shaper vector includes locations associated with a plurality of interfaces.

13. The article of claim 12, wherein the shaper vector has a series of bits indicating which interfaces are available to transmit packets, and said updating comprises:
updating the appropriate bit in the shaper vector.

14. The article of claim 13, wherein the calendar structure has a series of entries associated with time periods, each entry having a series of bits indicating which interfaces will become available to transmit packets during the time period associated with the entry.

15. The article of claim 14, wherein said updating comprises:
combining the shaper vector and the appropriate entry in the first portion of the calendar structure using an OR operation and storing the result in the shaper vector.

16. The article of claim 12, wherein execution of the instructions further results in:
pre-fetching a subset of the second portion of the calendar structure from the external memory and locally storing the subset at the processing element as the first portion.

17. The article of claim 16, wherein said pre-fetching comprises:
clearing the first portion of the calendar structure,
retrieving the subset of the second portion from the external memory, and
combining the retrieved information with the first portion using an OR operation and storing the result in the first portion of the calendar structure.

18. The article of claim 12, wherein execution of the instructions further results in:
determining a packet to be transmitted via a first interface,
updating a location in the shaper vector to indicate that the first interface is not available,
calculating a time when the first interface will again be available, and
updating an entry in the calendar structure to indicate when the interface will again become available.

19. The article of claim 18, wherein execution of the instructions further results in:
selecting the first interface based on information stored in the shaper vector.

20. The article of claim 18, wherein said calculating comprises dividing the length of the packet by a transmission rate associated with the first interface.

21. The article of claim 18, wherein execution of the instructions further results in:
determining whether the entry in the calendar structure to be updated is stored in the first portion of the calendar structure.

22. An apparatus, comprising:
a processing element to locally store a first portion of a calendar structure; and
a memory external to the processing element to store a second portion of the calendar structure,
wherein the calendar structure is associated with a plurality of interfaces and has a series of entries associated with time periods, each entry indicating which interfaces will become available to transmit packets during the associated time period.

23. The apparatus of claim 22, wherein the processing element is further to locally store a shaper vector indicating which interfaces are currently available to transmit packets.

24. A system, comprising:
a network processor, including:
a processing element to locally store a first portion of a calendar structure, and
a memory external to the processing element to store a second portion of the calendar structure,
wherein the calendar structure is associated with a plurality of interfaces and has a series of entries associated with time periods, each entry indicating which interfaces will become available to transmit packets during the associated time period; and
an asynchronous transfer mode fabric interface device coupled to the network processor.

25. The system of claim 24, wherein the processing element is further to store a shaper vector indicating which interfaces are currently available to transmit packets.
